(19) United States
(12) Patent Application Publication
(10) Pub. No.: US 2022/0316445 A1
(43) Pub. Date: Oct. 6, 2022

(54) SkyPipes for Renewable Water and Power Production

(71) Applicant: Howard K. Schmidt, Hockley, TX (US)

(72) Inventor: Howard K. Schmidt, Hockley, TX (US)

(21) Appl. No.: 17/714,043

(22) Filed: Apr. 5, 2022

Related U.S. Application Data
(60) Provisional application No. 63/170,986, filed on Apr. 5, 2021.

(51) Int. Cl. F03D 9/37; B01D 5/00

(52) U.S. Cl. CPC F03D 9/37; B01D 5/0057; B01D 5/0012; F05B 2260/24; F05B 2240/131; F05B 2250/231

(57) ABSTRACT

An apparatus for condensing water and producing electricity. In one embodiment, the apparatus may comprise a plurality of fabricated tubes, wherein the tubes may be filled with and enclose hydrogen, helium, or combinations thereof, and wherein the tubes may be bonded together lengthwise in a circular assembly to provide a cylindrical structure comprising a central bore. Further, the apparatus may comprise and a ground structure, wherein a lower portion of the cylindrical structure may be tethered to the ground structure.

### CROSS-REFERENCE TO RELATED APPLICATIONS

This application is a non-provisional application that claims the benefit of U.S. Application Ser. No. 63/170,986 filed on Apr. 5, 2021, the disclosure of which is incorporated by reference herein in its entirety.

### STATEMENT REGARDING FEDERALLY SPONSORED RESEARCH OR DEVELOPMENT

Not applicable.

### BACKGROUND OF THE INVENTION

### Field of the Invention

The present invention relates to the field of renewable water and/or power production. More particularly, the present invention relates to a lighter than air apparatus and/or structure that concentrates and directs airflow upwards to exploit adiabatic cooling and condensation, and thereby provides a renewable means for producing water and/or power.

### Background of the Invention

Energy transition to a renewable zero-carbon economy may be a daunting challenge, and a key component of American energy security and independence. In this transition, aside from nuclear power, operators have to pin their hopes on incoming solar radiation, either directly or indirectly. Essentially all renewable energy sources of consequence depend on either direct incoming radiation (solar panels), convection (wind power) or evaporation (hydroelectric power). The evaporation channel for absorbed power may generally be neglected, even though it may be five times larger than convection, the source of wind energy. At the same time, operators have to note that the evaporation channel of solar energy may be the source of all fresh water on the planet. To complete this perspective, operators should also note that fully half of all solar power absorbed at the surface ends up getting stored at least temporarily in the form of water vapor. Some of the most powerful forces on earth (e.g., hurricanes, tornadoes and thunderstorms) result from concentration and rapid release of solar energy stored in the form of water vapor. This invention may provide a means for exploiting this overlooked resource, initially for condensing clean water and eventually for producing electricity.

### BRIEF SUMMARY OF SOME OF THE PREFERRED EMBODIMENTS

These and other needs in the art are addressed in one embodiment by an apparatus for condensing water and producing electricity that may comprise a plurality of fabricated tubes, wherein the tubes may be filled with and enclose hydrogen, helium, or combinations thereof, and wherein the tubes may be bonded together lengthwise in a circular assembly to provide a cylindrical structure comprising a central bore. Further, the apparatus may comprise and a ground structure, wherein a lower portion of the cylindrical structure may be tethered to the ground structure.

These and other needs in the art are addressed in one embodiment by a method for condensing water through adiabatic expansion and cooling that may comprise concentrating and lifting humid air through a central bore of a cylindrical structure to condense water above the Lifted Condensation Level (LCL), wherein the cylindrical structure may comprise a plurality of fabricated tubes, wherein the tubes may be filled with and enclose hydrogen, helium, or combinations thereof, and wherein the tubes may be bonded together lengthwise in a circular assembly, and a ground structure, wherein a lower portion of the cylindrical structure may be tethered to the ground structure. Further, the method may comprise collecting condensed water that runs down the central bore via the ground structure and generating power from updrafts produced above the Level of Free Convection (LFC) via a turbine disposed at the ground structure.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates surface solar energy balance;

FIG. 2 illustrates key elements of cloud and precipitation formation from parcel lifting;

FIG. 3 illustrates a SkyPipe schematic according to embodiments of the present invention;

FIG. 4 illustrates a SkyPipe fabrication according to embodiments of the present invention; and

FIG. 5 illustrates 1D modeling results of cooling and condensation from lifted parcels starting at 25° C. and 95% relative humidity according to embodiments of the present invention.

### DETAILED DESCRIPTION OF THE PREFERRED EMBODIMENTS

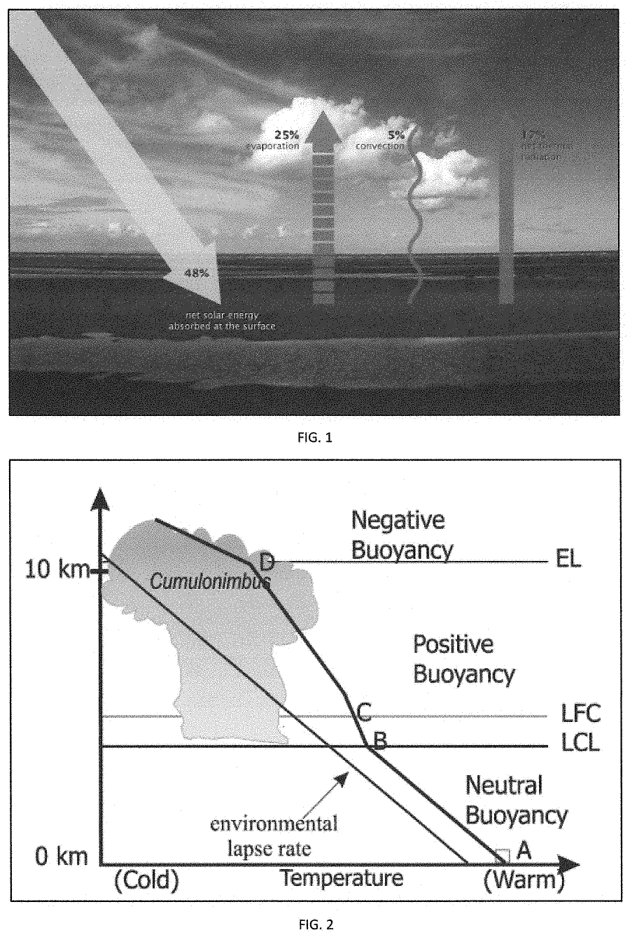

FIG. 1 illustrates surface solar energy balance. In particular, FIG. 1 illustrates that of the 48% net solar energy absorbed by the earth's surface, 25% may be utilized for the production of water vapor through evaporation, 5% may be utilized for generation of wind power through convection, and 17% may be given off as net thermal radiation. Based on these statistics, FIG. 1 illustrates that approximately half of the solar energy absorbed by the earth's surface may be directed toward the production of water vapor through evaporation.

FIG. 2 illustrates key elements of cloud and precipitation formation from parcel lifting. In particular, FIG. 2 illustrates the typical areas of negative, positive, and neutral buoyancy, as well as the approximate heights of the Lifted Condensation Level (LCL), the Level of Free Convection (LFC), and the Equilibrium Level (EL). Overall, FIG. 2 may illustrate that adiabatic expansion may lead to condensation and further, that released heat of condensation may generate powerful free convection in an upward direction.

In embodiments, a SkyPipe may be a novel structure and/or apparatus for concentrating and lifting humid air and causing condensation of pure water through adiabatic expansion and cooling. The SkyPipe itself may essentially be an updraft chimney designed to exploit the basic atmospheric physics underlying in cloud, rain, and storm formations. The structure may be similar to solar updraft towers (SUTs) used and proposed for extracting power from solar heated air. However, SUTs differ from SkyPipes in two important ways. First, SUTs may depend on using extremely dry air to minimize atmospheric heat capacity and maximize expansion and lift, whereas SkyPipes depend on humidity, (the more the better) and may function well with relative humidity of 60% or more. Second, all SUT designs known are rigid structures built from the ground up, whereas SkyPipes may literally reach new heights by using inflatable lighter-than-air fabrication methods to realize a buoyant self-supporting chimney structure.

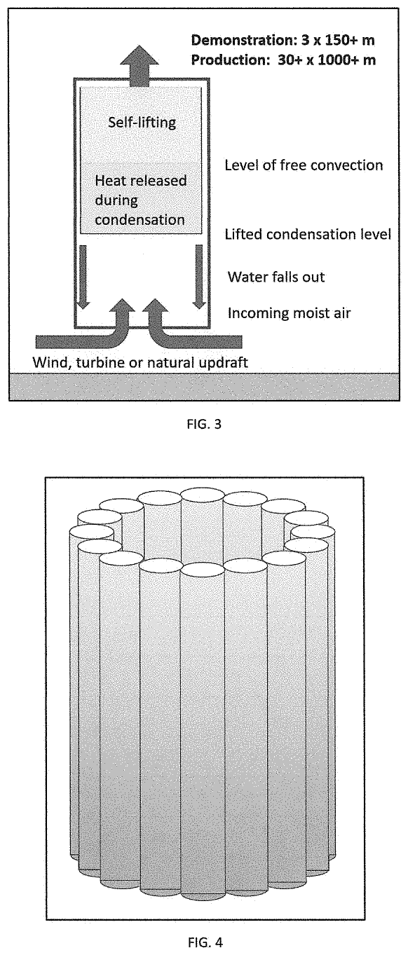

FIG. 3 illustrates a SkyPipe schematic. In particular, FIG. 3 illustrates that incoming humid or moist air may be lifted via wind, turbine, or natural updraft to condense into fresh water above the LCL. Further, if the SkyPipe is tall enough, power may be generated from updrafts above the LFC caused by the heat released during condensation. The SkyPipe may be any suitable height. In embodiments, the SkyPipe may have a height of at least about 150 meters, or alternatively between about 150 meters and about 1000 meters, or further alternatively more than about 1000 meters.

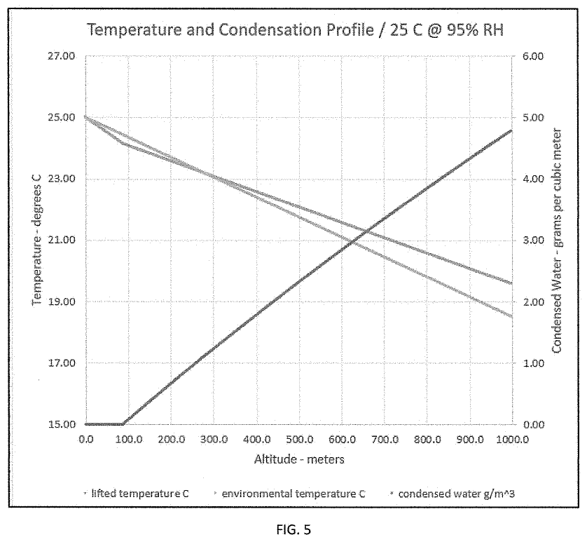

FIG. 4 illustrates an example SkyPipe fabrication. In embodiments, the SkyPipe may be a tower comprising a plurality of tubes bonded together lengthwise in a circular assembly by any suitable method to provide a cylindrical structure. While the diameter of each tube may only need to be big enough to support itself when inflated, the nominal outside diameter of the cylindrical structure may be at least about 3 meters, or alternatively between about 3 meters and about 300 meters, or further alternatively more than about 300 meters. In embodiments, each of the tubes may be fabricated from materials having mechanical strength and the ability to impede gas permeation such as, without limitation, a UV stabilized polyethylene, a polymer filled fabric, a fiber reinforced polymer, a nano-clay loaded polymer, or any combinations thereof. The material for each of the tubes may be, without limitation, polyethylene, polypropylene, polyester, polycarbonate, polyamides, polyimides, epoxies, urethanes, polyolefins, mylar, flourinated polymers, UV stabilized polymers, nanomaterial reinforced polymers, polymer nanocomposites, aluminum films, rubberized dacron, silk, polymer infused fabrics, or any combinations thereof. In embodiments, each of the tubes may be filled with and enclose hydrogen, helium, or combinations thereof, allowing the SkyPipe to be lighter than air and self-supporting, and thus eliminating costly rigid fabrication materials. Depending on the weight/thickness of the material, there may be a certain minimum volume to area ratio needed for the gas to support the SkyPipe when inflated. Although, in some embodiments, lifting structures may be utilized to further support the overall structure of the SkyPipe. These lifting structures may include, without limitation, traditional aerostats, blimps, or airships tethered to the SkyPipe from the top or above. In some embodiments, particularly those in which there may be high flow rates, Bernoulli forces may require the addition of composite or metallic hoops that reinforce the major diameter of the cylindrical structure. In embodiments, the hoops may be on the inside or the outside of the cylindrical structure and thereby may maintain the cylindrical structure and a major flow path inside the SkyPipe despite wind load and Bernoilli forces.

Generally, the SkyPipe may be an elongated vertical aerostat. Similar topologies may be realized by alternative fabrication schemes like a spiral winding of one long tube, or a series of rectangular boxes (like sleeping bags or parkas), or alternative hollow structures with skin over framework more like a traditional blimp or airship. In some embodiments, for purposes of producing water, but not power, the SkyPipe may have an overall sail-like structure rather than a chimney, such that the SkyPipe catches wind at its surface and directs airflow upwards. This sail-like structure may be gas filled and self-supporting with or without additional lifting structures to provide additional support, similar to the chimney structured SkyPipe. Regardless of the fabrication scheme, the entire structure may be flexible and expected to bend in wind, thus eliminating the need for extensive structural bracing to resist lateral wind loads.

In embodiments, the SkyPipe may be tethered to a ground station or structure that may be configured to collect and direct wind to force air up the structure. When the air reaches the LCL, condensation removes water from the updraft continuously. As such, the water may run down the walls of the chimney to a collector at the ground level. In some embodiments, a turbine may also be employed to initiate updraft, and particularly under favorable conditions (e.g., high humidity and a SkyPipe taller than the LFC), the turbine may be used to extract power from the updraft.

To further illustrate various illustrative embodiments of the present invention, the following theoretical example is provided.

### EXAMPLE 1

FIG. 5 illustrates a simple 1D model that captures the key physics of lifting, cooling, condensation and free convection. Further, FIG. 5 shows expected results starting with 25° C. air at 95% relative humidity. These conditions occur regularly in coastal areas between midnight and dawn. Condensation starts (LCL) by 100 meters, and free convection (LFC) starts by 300 meters, assuming the environmental lapse rate matches the global average of 6.5 C/km. The area between the lifted and environmental temperature curves represents work needed to lift the parcel to the LFC or the energy released by the freely convecting parcel above the LFC. If the tower is tall enough, the energy released by condensation exceeds the energy needed to lift and initiate the process and the excess energy can be extracted as wind power.

Although the present invention and its advantages have been described in detail, it should be understood that various changes, substitutions and alterations may be made herein without departing from the spirit and scope of the invention as defined by the appended claims.

What is claimed is:

1. An apparatus for condensing water and producing electricity comprising:
a plurality of fabricated tubes, wherein the tubes are filled with and enclose hydrogen, helium, or combinations thereof, and wherein the tubes are bonded together lengthwise in a circular assembly to provide a cylindrical structure comprising a central bore; and
a ground structure, wherein a lower portion of the cylindrical structure is tethered to the ground structure.

2. The apparatus of claim 1, wherein the cylindrical structure has a height of more than about 1000 meters.

3. The apparatus of claim 1, wherein the cylindrical structure has a nominal outside diameter between about 3 meters and about 300 meters.

4. The apparatus of claim 1, wherein each of the tubes are fabricated from materials having mechanical strength and the ability to impede gas permeation such as a UV stabilized polyethylene, a polymer filled fabric, a fiber reinforced polymer, a nano-clay loaded polymer, or any combinations thereof.

5. The apparatus of claim 1, wherein each of the tubes are fabricated from polyethylene, polypropylene, polyester, polycarbonate, polyamides, polyimides, epoxies, urethanes, polyolefins, mylar, flourinated polymers, UV stabilized polymers, nanomaterial reinforced polymers, polymer nanocomposites, aluminum films, rubberized dacron, silk, polymer infused fabrics, or any combinations thereof.

6. The apparatus of claim 1, wherein the cylindrical structure is self-supporting.

7. The apparatus of claim 1, further comprising an aerostat, blimp, or airship lifting structure tethered to an upper portion of the cylindrical structure to provide additional support.

8. The apparatus of claim 1, further comprising metallic or composite hoops disposed inside or outside the cylindrical structure to provide additional support.

9. The apparatus of claim 1, wherein the ground structure comprises a turbine configured to collect and direct wind and force air up the central bore.

10. The apparatus of claim 9, wherein the turbine is configured to extract power from produced updraft.

11. A method for condensing water through adiabatic expansion and cooling comprising:
(A) concentrating and lifting humid air through a central bore of a cylindrical structure to condense water above the Lifted Condensation Level (LCL), wherein the cylindrical structure comprises:
a plurality of fabricated tubes, wherein the tubes are filled with and enclose hydrogen, helium, or combinations thereof, and wherein the tubes are bonded together lengthwise in a circular assembly; and
a ground structure, wherein a lower portion of the cylindrical structure is tethered to the ground structure; and
(B) collecting condensed water that runs down the central bore via the ground structure;
(C) generating power from updrafts produced above the Level of Free Convection (LFC) via a turbine disposed at the ground structure.

12. The method of claim 11, wherein the cylindrical structure has a height of more than about 1000 meters.

13. The method of claim 11, wherein the cylindrical structure has a nominal outside diameter between about 3 meters and about 300 meters.

14. The method of claim 11, wherein each of the tubes are fabricated from materials having mechanical strength and the ability to impede gas permeation such as a UV stabilized polyethylene, a polymer filled fabric, a fiber reinforced polymer, a nano-clay loaded polymer, or any combinations thereof.

15. The method of claim 11, wherein each of the tubes are fabricated from polyethylene, polypropylene, polyester, polycarbonate, polyamides, polyimides, epoxies, urethanes, polyolefins, mylar, flourinated polymers, UV stabilized polymers, nanomaterial reinforced polymers, polymer nanocomposites, aluminum films, rubberized dacron, silk, polymer infused fabrics, or any combinations thereof.

16. The method of claim 11, wherein the cylindrical structure is self-supporting.

17. The method of claim 11, wherein an aerostat, blimp, or airship lifting structure is tethered to an upper portion of the cylindrical structure to provide additional support.

18. The method of claim 11, wherein metallic or composite hoops are disposed inside or outside the cylindrical structure to provide additional support.

19. The method of claim 11, wherein the turbine is configured to collect and direct wind and force air up the central bore.
